(19) United States
(12) Patent Application Publication
(10) Pub. No.: US 2016/0358143 A1
(43) Pub. Date: Dec. 8, 2016

(54) Methods And Apparatuses For Tracking Service Provider Affiliations For Events Within A Machine-To-Machine Network

(71) Applicant: Telefonaktiebolaget L M Ericsson (publ), Stockholm (SE)

(72) Inventor: George Foti, Dollard des Ormeaux (CA)

(21) Appl. No.: 14/759,422

(22) PCT Filed: Jun. 8, 2015
(86) PCT No.: PCT/IB2015/054329

§ 371 Date: Jul. 7, 2015

(51) Int. Cl. G06Q 20/14; G06Q 20/30

(52) U.S. Cl. CPC G06Q 20/14; G06Q 20/30

(57) ABSTRACT

According to one aspect of the teachings disclosed herein, a Machine-to-Machine, M2M, support entity within a M2M network is configured to identify the M2M Service Provider, SP, affiliations of the M2M entities and the M2M resources involved in a given transaction supported by the M2M support entity. Moreover, the support entity is configured to generate corresponding transaction records that are tagged with or otherwise store the M2M SP affiliation information, for billing usage. Consequently, usage of the support entity by more than one M2M SP can be differentiated for billing purposes. This functionality allows, for example, a second, smaller or less financially capable M2M SP to use the M2M gateways and/or other support entities of a larger or better-established M2M SP, and, in turn, allows the larger M2M SP to increase its revenue by expanding usage of its M2M network.

### TECHNICAL FIELD

The present invention generally relates to Machine-to-Machine or M2M networks, and particularly relates to tracking service provider affiliations for events within an M2M network, such as for charging when M2M entities affiliated with one M2M Service Provider, SP, use or operate within the M2M network of another M2M SP.

### BACKGROUND

Machine-to-Machine, M2M, networks involve the automated exchange of data and control signaling between various M2M entities. Here, a M2M “entity” is a logically distinct and separately identifiable thing within the M2M network. A M2M entity comprises, for example, the particular instance of a M2M application, as instantiated on a supporting device or node that provides a communication interface usable for communicating with one or more other M2M entities in the M2M network. While the term “M2M entity” has a logical connotation to it, it should be understood that, unless specified otherwise, the term “M2M entity” as used herein shall be understood as at least implicitly referring to the processing and communication circuitry by which the functionality of the M2M entity is realized. Of course, the same physical node may be used to implement more than one M2M entity. For example, a node having suitable processing circuitry and storage may host more than one M2M application—each such application instance operates as a distinct M2M entity within the overall M2M network and thus has its own identity and “location” within the network. However, unless otherwise noted for the sake of clarity, the terms “M2M entity” and “M2M node” are used interchangeably herein.

In a working M2M example, M2M nodes having various sensing capabilities are embedded in the heavy equipment used in a mining or large construction project. These M2M nodes are configured to send vehicle health and usage data to a remote application server hosting a software application that uses the reported data for scheduling vehicle maintenance. Many other examples come to mind, including the use of M2M nodes embedded in a network of geographically distributed vending machines, where each M2M node provides connectivity back to a network-based application that tracks item stock levels, machine functionality, etc. Broadly, M2M technology may be applied to an essentially unlimited range of applications and contexts and, in general, can be understood as being part of the evolving Internet of Things, IoT.

In a base scenario, a M2M Service Provider, SP, owns or otherwise controls certain network infrastructure, such as various M2M gateways and other “support” nodes, that provide for the registration of M2M nodes within the network, and for the organized collection of data and exchange of signaling between one or more M2M application servers and a potentially large number of M2M entities deployed in the field. The deployed M2M entities included in a given M2M network may all be of the same type, or there may be a mix of M2M entities types. Here, an M2M node may be dedicated to M2M usage, or it may have other or additional functionality. For example, a given node may host one or more M2M software applications, along with one or more other non-M2M software applications.

The M2M network infrastructure provided by the M2M SP may be used strictly for the needs of that particular M2M SP. For example, a large company or public utility may implement its own M2M network to support its own M2M devices. In other scenarios, however, the M2M SP allows third parties to use all or parts of its network infrastructure, e.g., on a subscription basis. This latter arrangement represents an example of potentially different companies subscribing to or otherwise paying for M2M network support, as provided by the involved M2M SP.

It should also be noted that other communication networks may be involved, such as where the field-deployed M2M entities use cellular networks to access the M2M network. The cellular network operator or operators may be distinct from the M2M SP that operates the M2M network. Of course, the M2M network infrastructure provided by a given M2M SP may be accessible through the Internet, and cellular networks represent merely one example of the mechanisms by which remote M2M devices may communicate with a M2M network.

To better understand M2M networks, one may refer to the examples provided in the standardization specifications promulgated by the “oneM2M” organization. For example, the technical specification TS-0001-V1.6.1 defines the functional architecture of a M2M network configured according to the oneM2M standards. According to oneM2M, a “Machine-to-Machine Solution is a combination of devices, software and services that operate with little or no human interaction,” and a M2M network shall be understood as comprising one or more “Application Entities” or AEs.

A given AE may be an ADN-AE, where “ADN” denotes an “Application Dedicated Node”. ADN-AEs generally are part of the “field domain” of a M2M network. AEs may also exist in the so-called “middle nodes” or MNs that interconnect M2M entities in the field domain to supporting M2M entities in the “infrastructure domain”. For example, a MN “Common Services Entity” or MN-CSE is a type of M2M support entity, and may act as a gateway for coupling any number of field-domain AEs to an Infrastructure Node CSE or IN-CSE. An IN-CSE is a type of “top-level” M2M support entity within the M2M network domain, and there generally is only one IN-CSE within a given M2M network. An IN-CSE may include or may otherwise communicate with one or more IN-AEs. The IN-AEs comprise, for example, the top-level M2M applications that collect data from field-domain AEs and/or provide overall control or management for the field-domain AEs and their data.

In the oneM2M context, a CSE represents an instantiation of a set of common service functions that are exposed to other M2M entities through defined communication interfaces, known as “reference points”. Example CSE functions include data management, subscription service management, and location services. Of course, the applicability of the teachings presented in this disclosure is not limited to M2M networks implemented according to the oneM2M standards, and it will be appreciated that CSEs can be understood as an example of a M2M “support node” or “support entity” that supports other M2M entities in the M2M network, such as by providing registration services, resource hosting, etc.

With the increasing sophistication of M2M applications and the increasing scale and diversity of M2M deployments, it is recognized herein that M2M SPs face significant design challenges and expenses in deploying and maintaining their M2M networks. Indeed, it is recognized herein that in some scenarios, it may be much more feasible for one M2M SP to lease or otherwise pay to use at least certain parts of an M2M network that is owned by another M2M SP. For example, it is contemplated herein for a first M2M SP to lease usage of the MN-CSEs or other gateway nodes of a second M2M SP having a larger or more strategically deployed M2M network. Such an arrangement would provide an economical mechanism for communicatively linking AEs of the first M2M SP to the back-end infrastructure of the first M2M SP, via the gateways of the second M2M SP. Other usage scenarios are also contemplated, such as where one M2M SP pays for the use of processing time and/or storage on the IN-CSE of another M2M SP.

Notably, the existing M2M protocols and standards provide for certain interoperability between the M2M networks of different M2M SPs. However, it is recognized herein that the current protocols and standards do not provide for an efficient and ready mechanism for tracking usage of M2M network nodes or resources by different M2M SPs within the same M2M network domain.

### SUMMARY

According to one aspect of the teachings disclosed herein, a Machine-to-Machine, M2M, support entity within a M2M network is configured to identify the M2M Service Provider, SP, affiliations of the M2M entities and the M2M resources involved in a given transaction supported by the support entity. Moreover, the support entity is configured to generate corresponding transaction records that are tagged with or otherwise store the M2M SP affiliation information, for billing usage. Consequently, usage of the M2M support entity by more than one M2M SP can be differentiated for billing purposes. This functionality allows, for example, a second, smaller or less financially capable M2M SP to use the M2M gateways and/or other M2M support entities of a larger or better-established M2M SP, and, in turn, allows the larger M2M SP to increase its revenue by expanding usage of its M2M network.

One embodiment involves a method at a M2M support entity operating in a M2M network. The M2M support entity provides support for M2M transactions involving given M2M entities and given M2M resources in the M2M network. According to the method, the M2M support entity identifies the transaction initiator and the transaction target, for any given M2M transaction being supported by it. Here, the transaction initiator is the particular M2M entity in the M2M network that initiated the transaction and the transaction target is the particular M2M resource in the M2M network that is targeted by the given transaction.

The method further includes identifying M2M SP affiliations of the transaction initiator and the transaction target, generating a transaction record for the given transaction, and including in the transaction record the M2M SP affiliations of the transaction initiator and the transaction target. Still further, the method includes storing the transaction record at least temporarily in storage at the M2M support entity, and forwarding the transaction record, or a Charging Data Record, CDR, derived therefrom, towards a billing system associated with the M2M network, for billing in dependence on the M2M SP affiliations of the transaction initiator and the transaction target.

In another embodiment, a M2M support entity is configured for operation in a M2M network that includes a number of M2M entities, where various ones of the M2M entities may be affiliated with different M2M SPs. The M2M support entity is implemented at a first M2M node configured for operation in the network and comprises one or more communication interfaces and processing circuitry operatively associated with the one or more communication interfaces. The one or more communication interfaces are configured to send and receive M2M signaling to one or more other M2M entities and the processing circuitry is operative to support M2M transactions involving given M2M entities and given M2M resources in the M2M network. In particular, the processing circuitry is configured to identify the transaction initiator and the transaction target, for a given transaction being supported by the M2M support entity. The transaction initiator comprises the given M2M entity in the M2M network that initiated the transaction and the transaction target comprises the given M2M resource in the M2M network that is targeted by the given transaction.

The processing circuitry is further configured to identify the M2M SP affiliations of the transaction initiator and the transaction target, generate a transaction record for the given transaction, and include in the transaction record the M2M SP affiliations of the transaction initiator and the transaction target. Further, the processing circuitry of the M2M support entity is configured to store the transaction record at least temporarily in storage at the M2M support entity, and forward the transaction record, or a CDR derived therefrom, towards a billing system associated with the M2M network. This forwarding provides for billing in dependence on the M2M SP affiliations of the transaction initiator and the transaction target.

In another example embodiment, a first M2M support entity is configured for operation in a M2M network that includes a number of other M2M entities, where given ones of the M2M entities may be associated with different M2M SPs. The M2M support entity, M2M SE, comprises a communication module for sending and receiving M2M signaling to one or more of the other M2M entities and a number of further modules for supporting M2M transactions involving given M2M entities and given M2M resources in the M2M network that are affiliated with different M2M SPs.

The further modules include: a first identifying module for identifying a transaction initiator and a transaction target, for a given transaction being supported by the M2M SE, where the transaction initiator comprises the given M2M entity in the M2M network that initiated the transaction and the transaction target comprises the given M2M resource in the M2M network that is targeted by the given transaction; a second identifying module for identifying M2M SP affiliations of the transaction initiator and the transaction target; a generating module for generating a transaction record for the given transaction, and including in the transaction record the M2M SP affiliations of the transaction initiator and the transaction target; a storing module for storing the transaction record at least temporarily in storage at the M2M SE; and a forwarding module for forwarding the transaction record, or a CDR derived therefrom, towards a billing system associated with the M2M network, for billing in dependence on the M2M SP affiliations of the transaction initiator and the transaction target.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a M2M network.

FIG. 2 is a block diagram of one embodiment of a given M2M entity acting as a transaction initiator that initiates a transaction targeting a given M2M resource, and a M2M support entity that is configured to support the transaction.

FIG. 3 is a block diagram of known structure for storing M2M resources at a M2M node.

FIG. 4 is a logic flow diagram of one embodiment of a method of operation at an M2M node configured for operation in a M2M network as an Infrastructure Node Common Services Entity or IN-CSE, as an example of a M2M support entity.

FIGS. 5-8 are call or signaling flow diagrams for tracking M2M SP affiliations within an M2M network, according to one or more embodiments.

FIG. 9 is a block diagram of another embodiment of an M2M network, showing multiple instances of CSEs, as different M2M support entities that are affiliated with different M2M SPs and are interconnected within a M2M network.

FIGS. 10-13 are call or signaling flow diagrams for tracking M2M SP affiliations within an M2M network, according to one or more embodiments.

FIG. 14 is a block diagram of another embodiment of a M2M support entity.

### DETAILED DESCRIPTION

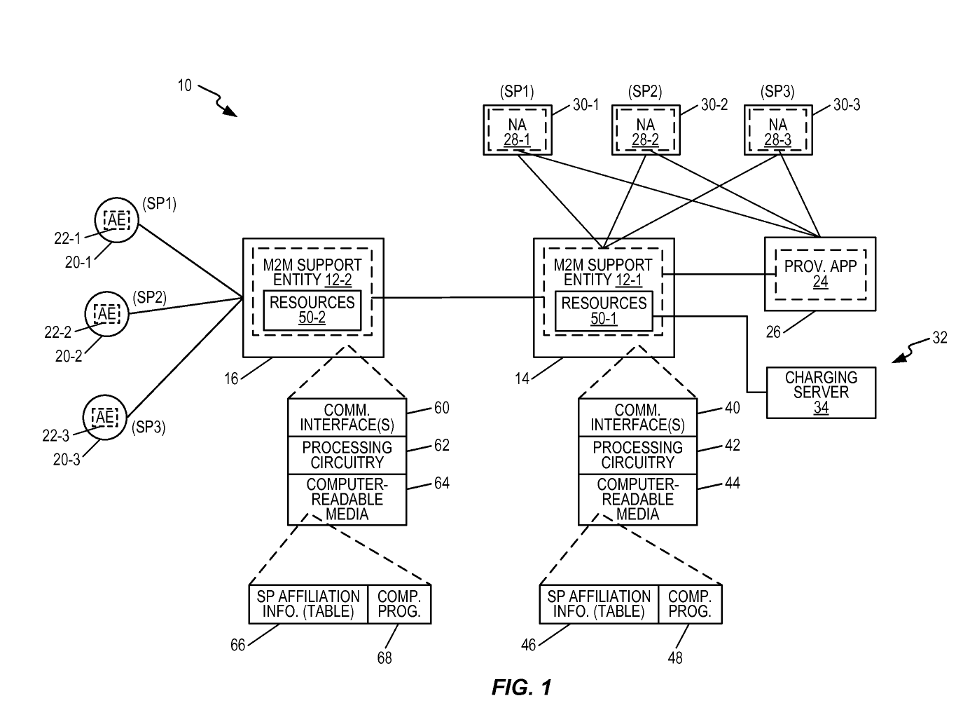

FIG. 1 illustrates a Machine-to-Machine, M2M, network 10, which may be regarded as defining a M2M network domain. It will be appreciated that M2M networks are subject to significant variation and that the M2M network 10 is offered as a non-limiting example for discussing various embodiments of the teachings herein.

The M2M network 10 may be regarded as comprising various M2M entities. As noted earlier in this disclosure, an M2M entity is any logically defined entity within the M2M network domain, such as any instance of an M2M application or any M2M service instance within the M2M network 10. Each M2M entity has an M2M identity within the M2M network domain and each M2M entity necessarily is realized or otherwise instantiated via processing circuitry and, in general, one or more types of memory and/or storage. As such, this disclosure uses the terms “M2M node” and “M2M entity” interchangeably, unless a specific distinction is needed for clarity. Consequently, references herein to a “M2M node” can be understood as implicitly referencing a particular M2M entity within the M2M network domain.

The various M2M entities in the M2M network 10 create, manage, access and use M2M “resources”. For example, registration resources maintained by a given M2M entity indicate the various other entities that have registered with the given M2M entity. Of more interest herein, however, are data resources associated with the collection and processing of data, e.g., “field data” collected by one or more M2M entities that are deployed in the field domain of the M2M network 10. These data resources may be transferred between M2M entities, or one M2M entity may read or write the data resources maintained by another M2M entity in the same or another M2M node. Of course, the acquisition, transfer, processing, aggregation and accessing of data resources may be strictly controlled based on defined ownership and permission/access-control policies and managed according to the M2M Identifiers, IDs, of the various M2M entities.

With the above general concepts in mind, the example M2M network 10 includes a number of M2M entities, such as M2M support entities, SEs, 12-1 and 12-2, which are hosted on respective nodes 14 and 16, along with a number of field-deployed M2M application entities, AEs, 22-1, 22-2 and 22-3, which are hosted on respective nodes 20-1, 20-2, and 20-3. There may be a fewer or more AEs 22 and/or more or fewer SEs 12 in the M2M network 10. Correspondingly, the reference number “12” without suffixing is used herein to generically refer to any given SE or SEs in the M2M network 10. Likewise, the reference number “22” without suffixing is used herein to generically refer to any given AE or AEs in the M2M network 10.

The M2M network 10 further includes or is associated with a provisioning application 24 hosted at a provisioning application server 26, and further includes or is associated with a number of M2M network applications, NAs, 28. By way of example, three NAs 28 are shown, NA 28-1 is associated with a first M2M Service Provider or SP, SP1, and is hosted on a server 30-1, NA 28-2 is associated with a second M2M SP, SP2, and is hosted on a server 30-2, and NA 28-3 is associated with a third M2M SP, SP3, and is hosted on a server 30-3.

Note that the AE 22-1 is affiliated with SP1, the AE 22-2 is affiliated with SP2, and the AE 22-3 is affiliated with SP3. Assuming that the overall M2M network 10 is affiliated with SP1—e.g., owned or operated by SP1—the diagram can be understood as illustrating a case where SP2 and SP3 use all or at least a portion of the M2M network 10 to gain access to and/or provide M2M services for their field-deployed AEs 22. It may be that a given M2M SP does not own or deploy anything other than NAs 28 and AEs 22, while relying on another M2M SP to provide all of the supporting M2M infrastructure. In other instances, a given M2M SP may deploy AEs 22 and one or more gateways—a type of M2M SE 12—to connect its AEs 22 to the network infrastructure of another M2M SP. Of course, other permutations are possible, with respect to how different M2M SPs share or make use of M2M entities owned by another M2M SP.

Further, the various AEs 22 may be homogenous (of the same type) or heterogeneous (of mixed types). For example, in a utility metering context, a public utility may install “smart” meters at each of its metering locations, where each smart meter operates as an AE 22. More generally, each AE 22 may create various data resources and/or may transmit data for storage in resources managed or otherwise held at other M2M entities in the M2M network 10. Consequently, the M2M network 10 will be understood as supporting M2M transactions involving M2M entities and/or M2M resources that have differing M2M SP affiliations. Of course, the M2M network also supports transactions involving M2M entities and resources having the same SP affiliations.

A provisioning application 24 running on a provisioning application server 26 is configured in one or more embodiments herein to provide provisioning information to the top-level SE M2M SE 12-1, regarding the M2M SP affiliations of the various M2M entities that are registered, or will be registered in the M2M network 10. For example, the provisioning application 24 provides the M2M SE 12-1 with the M2M SP affiliations of various AEs 22, which are identified by AE-IDs, such that the M2M SP affiliation will be known for any given AE 22 that registers with any given M2M SE 12 in the M2M network 10. The top-level SE M2M SE 12-1 may be configured to distribute or otherwise provide M2M SP affiliation information to any other M2M entity in the M2M network 10, such as by providing M2M SP affiliation information for AEs 22 that register with the M2M SE 12-2.

The availability, distribution and use of M2M SP affiliation information allows the M2M network 10 to identify the M2M SP affiliations of the M2M entities and resources involved in any transaction supported by the M2M network 10. In turn, that allows the controlling M2M SP to differentiate such transactions according to the M2M SPs involved in the transaction. Ultimately, generating transaction records that include the M2M SP affiliation information for the M2M entities and/or M2M resources involved in the transactions enables billing that is differentiated on a M2M SP basis.

The provisioning information provided in this example case by the provisioning server 26 enables the SP1 to identify the affiliations of the various M2M entities that register and operate in the M2M network 10, and that affiliation information in turn allows the involved M2M entities to dynamically determine the M2M SP affiliations for subsequently created M2M resources. Thus, a billing system 32, which comprises a charging server 34, for example, can be provided with information indicating which M2M SPs were involved in each chargeable event that is transacted within the M2M network 10. This arrangement means that SP2 and SP3 can act as full-serve M2M SPs with respect to their subscribers, despite not actually owning or controlling the M2M network 10—i.e., SP2 and SP3 in this example can be viewed as being “virtual” M2M SPs in the sense that they need not own or maintain the M2M network that allows them to provide M2M services to their subscribers or users.

Of course, it is also contemplated that a virtual M2M SP may own at least some M2M nodes. For example, a given M2M SP may own gateways that couple to the infrastructure of another M2M SP. Conversely, a given M2M SP may own its own top-level M2M SE 12, but may not own any the gateway or middle nodes needed to interface its top-level SE 12 to its field-deployed AEs 22. The teachings herein address these and other ownership/use scenarios, by allowing any given M2M node to know and track the M2M SP affiliations of the M2M entities and resources involved in any given M2M transaction supported by the node.

In an example embodiment, then, this disclosure teaches a first M2M node 14 or 16 that is configured for operation as a M2M SE 12 in a M2M network 10 that includes the first M2M node 14 or 16. The M2M network 10 includes a number of other M2M entities, e.g., other SEs 12, any number of AEs 22, and any number of network applications 28. Here, the phrase “14 or 16” shall be understood as being one or the other, or both. Indeed, the same “and/or” connotation applies to the use of “or” in this disclosure, unless otherwise noted or unless a “one or the other” meaning is clear from the context.

The first M2M node 14 or 16 and the M2M network 10 are affiliated with a first M2M SP, e.g., SP1. The first M2M node 14 or 16 comprises one or more communication interfaces 40 or 60 that are configured to send and receive M2M signaling to one or more of the other M2M entities 12, 22, and/or 28. The M2M node 14 or 16 further includes processing circuitry 42 or 62 and corresponding memory or storage, e.g., the M2M node 14 includes one or more types of computer-readable media 44 and the M2M node 16 includes one or more types of computer-readable media 64.

In at least one embodiment, the computer-readable media 44 of the M2M node 14 stores SP affiliation information 46 and may also store a computer program 48. The computer program 48 comprises computer program instructions that, when executed by a microprocessor or other digital processing circuitry, specially adapt one or more programmable circuits to operate as the processing circuitry 42 described herein. Similarly, in at least one embodiment, the computer-readable media 64 of the M2M node 16 stores SP affiliation information 66 and may also store a computer program 68. The computer program 68 comprises computer program instructions that, when executed by a microprocessor or other digital processing circuitry, specially adapt one or more programmable circuits to operate as the processing circuitry 62 described herein.

Note, too, that the SP affiliation information 46 as stored in the M2M node 14 may include information for all M2M entities that are or will be registered in the M2M network 10, and may include information for all M2M resources 50-1 that exists or will be created in the M2M network 10, or just for the M2M resources 50 that are hosted at the SE 12-1 implemented by the M2M node 14. The SP affiliation information 66 as stored in the M2M node 16 may include information for those M2M entities that are or will be registered at the SE 12-2 implemented by the M2M node 16, and may include information for the M2M resources 50-2 that are hosted at the SE 12-2. Note that the reference number “50” is used without suffixing to generically refer to any given M2M resource or resources, at any given M2M entity in the M2M network 10.

It will be appreciated that the processing circuitry 42 of the M2M node 14 is operatively associated with the one or more communication interfaces 40, and that the processing circuitry 62 of the M2M node 16 is operatively associated with the one or more communication interfaces 60. The processing circuitry 42 or 62 is operative to support M2M transactions involving given M2M entities 12, 22 and/or 28 and given M2M resources 50 in the M2M network 10 that are affiliated with different M2M SPs. Here, the term “M2M resources 50” particularly refers to M2M data that is collected, processed, accessed or modified by given M2M entities within the M2M network 10.

The processing circuitry 42 or 62 is, in particular, configured to identify a transaction initiator and a transaction target, for a given transaction being supported by the involved M2M SE 12. The transaction initiator comprises the given M2M entity in the M2M network 10 that initiated the transaction and the transaction target comprises the given M2M resource 50 in the M2M network 10 that is targeted by the given transaction. The processing circuitry 42 or 62 is further configured to identify the M2M SP affiliations of the transaction initiator and the transaction target, generate a transaction record for the given transaction, and include in the transaction record the M2M SP affiliations of the transaction initiator and the transaction target. Still further, the processing circuitry 42 or 62 is configured to store the transaction record at least temporarily in storage at the involved M2M SE 12, and forward the transaction record, or a CDR derived therefrom, towards the billing system 32, for billing in dependence on the M2M SP affiliations of the transaction initiator and the transaction target.

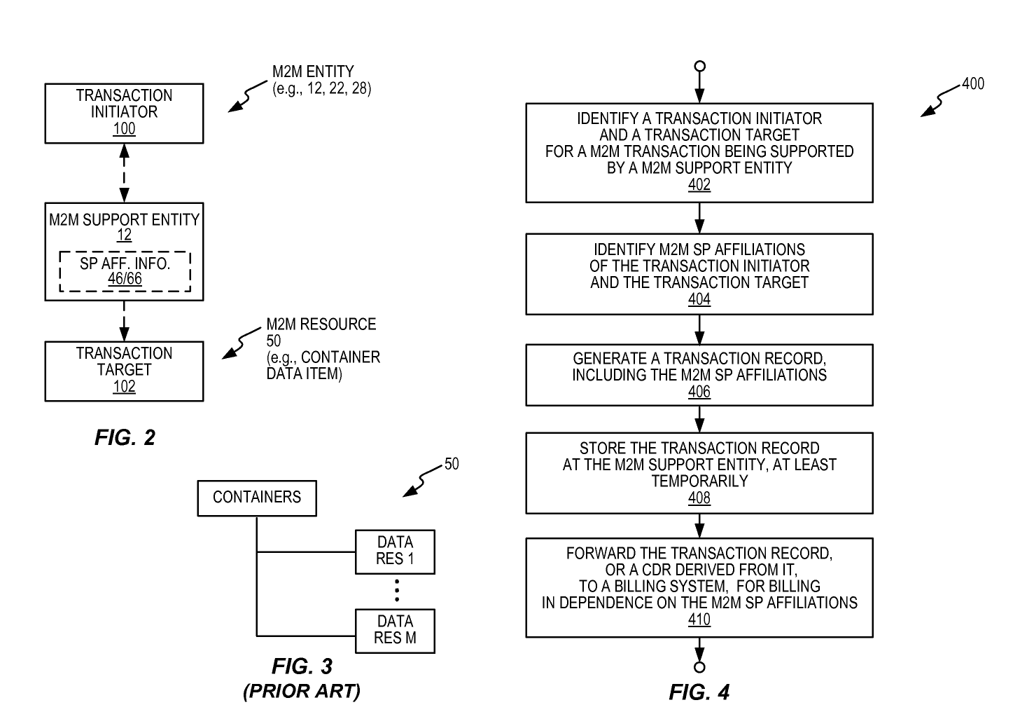

Referring now to FIG. 2, one sees an example of transaction initiator 100, e.g., a given M2M entity 12, 22 or 28 within the M2M network 10, that initiates a transaction targeting another M2M entity or resource 50 as a transaction target 102. The diagram further shows a M2M SE 12 in the M2M network 10 supporting the transaction. The illustrated M2M SE 12 is implemented in the node 14 or 16 of FIG. 1, for example, and therefore has access to SP affiliation information 46 or 66, so as to identify the M2M SP affiliations of the transaction initiator 100 and the transaction target 102. Also note that FIG. 3 illustrates a known structure for storing a data resource 50 at a given M2M entity/node in an M2M network.

In at least one embodiment, the processing circuitry 42 or 62 is configured to identify the M2M SP affiliations of the transaction initiator 100 and the transaction target 102 based on at least one of: information received by the M2M SE 12 in conjunction with the given transaction, and affiliation information stored in the M2M SE 12 in advance of the given transaction.

In the same or other embodiments, the processing circuitry 42 or 62 is configured to identify the M2M SP affiliations of the transaction initiator 100 and the transaction target 102 by at least one of: receiving a M2M identifier of the transaction initiator 100 and a M2M identifier of the transaction target 102, in M2M signaling received by the involved M2M SE 12, in conjunction with the transaction; and identifying the M2M SP affiliations of the transaction initiator 100 and the transaction target 102, using the affiliation information stored at the M2M SE 12, where the affiliation information maps the M2M identifiers received for the transaction initiator 100 and the transaction target 102 to respective M2M SP identifiers.

The teachings herein provide for M2M SP affiliation tracking in various cases or scenarios. Broadly, in one or more example embodiments, and for any given M2M event, any given M2M node involved in the event is configured to determine and record the M2M SP affiliations of some or all of M2M entities and M2M resources 50 involved in the event. In an example case, the transaction initiator 100 and the transaction target 102 are registered with or are otherwise hosted by the same M2M node. For example, an AE 22 is registered at a given M2M SE 12 and it initiates a transaction towards a M2M resource 50 that is stored at the same M2M SE 12. In such cases, the affiliation information for both transaction initiator 100 and the transaction target 102 is fetched by the involved M2M SE 12, e.g., using stored affiliation information.

In a second case, the transaction initiator 100 and the transaction target 102 are registered to or hosted by different M2M entities in separate nodes. In such cases, each M2M entity/node involved in the end-to-end transaction will have to determine the M2M SP affiliations from signaling. For example, assume that the transaction initiator 100 is registered at a first M2M SE 12 and that the transaction target 102 is stored at a second M2M SE 12. The end-to-end transaction thus involves both the first and second M2M SEs 12, and each one generates a corresponding transaction record that includes or indicates the M2M SP affiliations of the transaction initiator 100 and the transaction target 102. The second M2M SE 12 generally will have local SP affiliation information stored for the transaction target 102 and the first M2M SE 12 generally will have local SP affiliation stored for the transaction initiator 100.

In order for the first M2M SE 12 to also have SP affiliation information for the transaction target 102, for recording in its record of the transaction, the second M2M SE 12 sends the SP affiliation information for the transaction target 102 to the first M2M SE 12 in return signaling. Similarly, in order for the second M2M SE 12 to have the SP affiliation information for the transaction initiator 100, for recording in its record of the transaction, the first M2M SE 12 sends the SP affiliation information for the transaction initiator 100 to the second M2M SE 12. This inter-entity signaling between the first and second M2M SEs 12 may be carried out as part of or in conjunction with the M2M signaling going between them for the M2M transaction.

In another example case, the transaction initiator 100 is registered at a first M2M SE 12 that is acting as a gateway or middle node with respect to a second M2M SE 12, and the transaction target 102 is a M2M resource 50 held at second M2M SE 12. In cases like this, the initiating M2M SE 12, here, the first M2M SE 12 may provide the SP affiliation of the transaction initiator 100 to the second M2M SE 12, as part of or in conjunction with the transaction. However, the second M2M SE 12 in such cases generally will be a top-level SE and thus will have previously received provisioning information indicating the SP affiliation of the transaction initiator 100 and it may additionally or alternatively use that previously provisioned SP affiliation information when generating the transaction record. Similarly to previous example, the second M2M SE 12 may return SP affiliation information for the transaction target 102 to the first M2M SE 12 in return signaling.

Thus, in an example scenario or use case, a given M2M SE 12 in the M2M network supports a given M2M transaction. The given M2M SE 12 is associated with the transaction initiator 100 or with the transaction target 102. Correspondingly, the processing circuitry 42 or 62 of the given M2M SE 12 is configured to obtain the SP affiliation information for the transaction initiator 100 and/or the transaction target 102, based on signaling received at the M2M SE 12 as part of, or in conjunction, with the transaction.

In another example case, with respect to a given M2M SE 12 involved in a given M2M transaction, the M2M SE 12 knows the SP affiliation of the transaction initiator 100 and/or the transaction target 102 based on prior registration activities. For example, when an AE 22 is registered at the given M2M SE 12, the M2M SE 12 may already have provisioned service profile information that indicates the SP affiliation of the registering AE 22, or the M2M SE 12 may obtain such information from another M2M SE 12 during the registration process. For example, when an AE 22 is being registered at a given M2M SE 12-2 that is supported by a top-level M2M SE 12-1, the M2M SE 12-1 may provide SP affiliation information to the M2M SE 12-2. Similar operations also apply to the creation and storage of M2M resources 50.

It should also be noted that in some embodiments, the processing circuitry 42 or 62 of a given M2M SE 12 forwards its stored transaction records, or derived records, to the billing system 32. Advantageously, these forwarded records include M2M SP affiliation information for the involved transaction initiators 100 and the involved transaction targets 102. For example, when the M2M SE 12 in question comprises the M2M SE 12-2 shown in FIG. 1, it may not generate formal CDRs, and instead may forward the transaction records themselves to the billing system 32. On the other hand, if the M2M SE 12 in question is the top-level M2M SE 12-1 shown in FIG. 1, it may be configured to generate formal CDRs from the transaction records and to forward the CDRs, with or without forwarding the underlying transaction records, to the billing system 32. In either approach, however, the billing system 32 receives M2M SP affiliation data for chargeable events, which allows it to identify the M2M entities and resources involved in each such event.

These transaction records and/or derived CDRs may be forwarded individually to the billing system 32, or aggregated batches of them may be forwarded. For example, the transaction records and/or derived CDRs generated over some window of time may be batched together and forwarded, or batching may be based on record count.

FIG. 4 illustrates a corresponding method 400 at a given M2M SE 12 involved in a given M2M transaction. It will be appreciated that the M2M SE 12 is configured for operation in a M2M network 10, and that the M2M SE 12 in general is configured to support M2M transactions involving given M2M entities, e.g., entities 12, 22, 28, and given M2M resources 50 in the M2M network 10 that are, or can be, affiliated with different M2M SPs. In this context, the method 400 includes identifying (Block 402) a transaction initiator 100 and a transaction target 102, for a given transaction being supported by the M2M SE 12. Here, the transaction initiator 100 comprises a given M2M entity in the M2M network 10 that initiated the transaction, e.g., another M2M SE 12, a given AE 22, or a given network application 28. The transaction target 102 comprises a given M2M resource 50 in the M2M network 10 that is targeted by the given transaction. For example, the transaction initiator 100 targets a given M2M resource 50 for reading or writing, or for some other type of access.

The method 400 further includes identifying (Block 404) M2M SP affiliations of the transaction initiator 100 and the transaction target 102, generating (Block 406) a transaction record for the given transaction, and including in the transaction record the M2M SP affiliations of the transaction initiator 100 and the transaction target 102. Correspondingly, the method 400 includes storing (Block 408) the transaction record at least temporarily in storage at the M2M SE 12, and forwarding (Block 410) the transaction record, or a derived CDR, towards a billing system 32 associated with the M2M network 10, for billing in dependence on the M2M SP affiliations of the transaction initiator 100 and the transaction target 102.

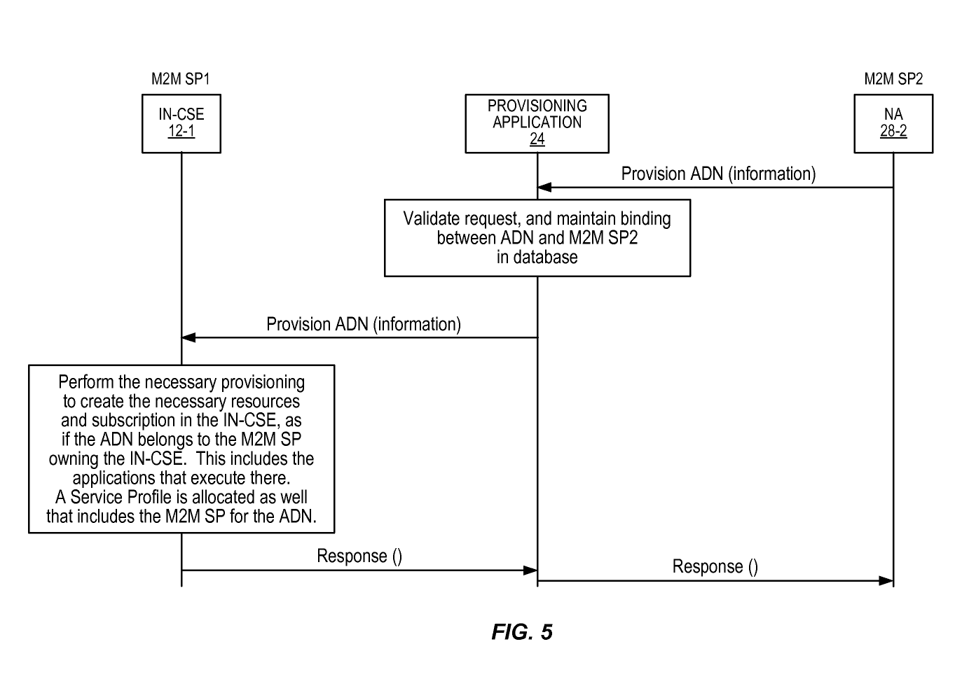

FIG. 5 illustrates a call flow—also referred to as a signaling flow—for provisioning SP affiliation information in the M2M network 10. As a non-limiting but useful example, the M2M entity/node names are presented using the nomenclature of oneM2M, see, e.g., TS-0001-V1.6.1. Thus, the M2M SEs 12 seen in FIG. 1, are denoted as Common Service Entities or CSEs. In particular, the M2M SE 12-2 is referred to as the MN-CSE 12-2, to denote its “middle node” role with respect to the M2M SE 12-2, which is referred to as the IN-CSE 12-1, to denote its “infrastructure node” or top-level role in the M2M network 10.

In the illustrated signaling flow, the NA 28-2 of SP2 provides information to the provisioning application 24 that identifies a particular ADN 20. Such information may include, for example, the M2M SP-ID associated with SP2, the M2M ADN-ID associated with the ADN 20, and possibly additional related information. For example, the provisioning information may include the AE-IDs of any AEs 22 to be instantiated at or otherwise hosted by the ADN 20.

The provisioning application 24 validates the provisioning request from SP2, and provides the ADN-related provisioning information to the IN-CSE 12-1 of the M2M network 10. In this example, one may assume that SP1 owns the M2M network 10 and the IN-CSE 12-1 and that SP1 acts as a lessor of the M2M network 10 and the IN-CSE 12-1, with SP2 acting as a lessee with respect to its use of the M2M network 10 and the IN-CSE 12-1.

The IN-CSE 12-1 creates a record that logically “binds” the M2M SP affiliation information to the ADN-ID and any dependent M2M identities received from the provisioning application 24. For example, the IN-CSE 12-1 may create a service profile for the ADN 20 and any other involved M2M entities. The service profile may be a separate data item or structure, or it may be embodied in the “resource trees” or other normal data storage used by the IN-CSE 12-1 to represent the ADN 20 in the M2M network 10.

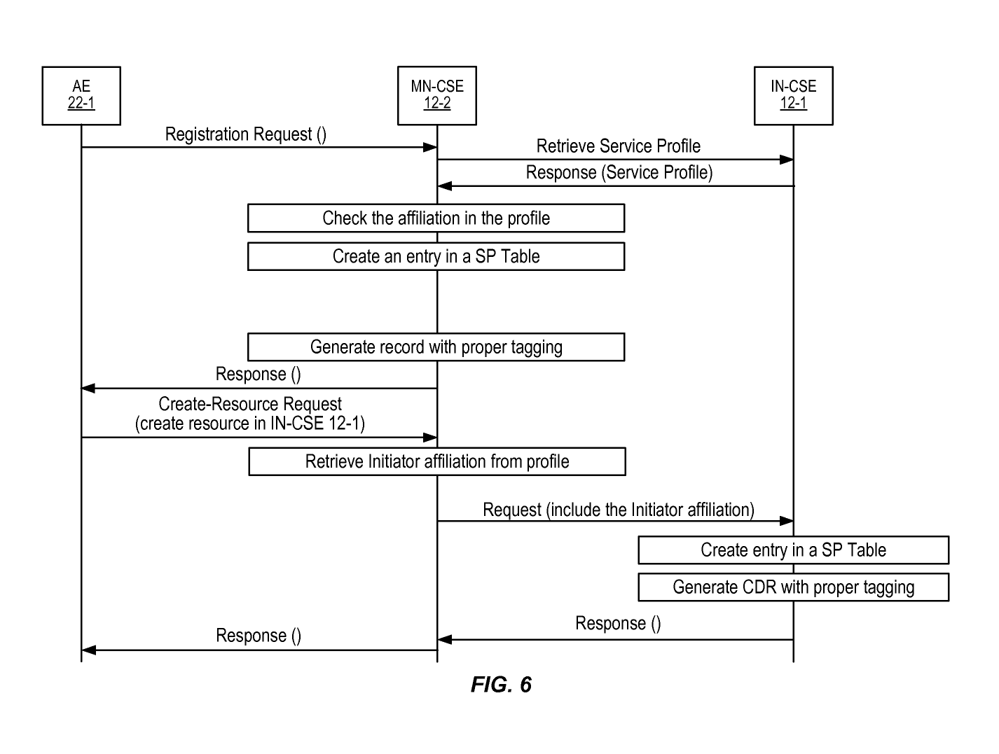

FIG. 6 illustrates an example of resource creation for an AE 22-1, for which the IN-CSE 12-1 previously received provisioning information and for which service profile information exists. In particular, one may assume that the IN-CSE 12-1 has service profile information for the AE 22-1. Thus, when the AE 22-1 sends a registration request towards the MN-CSE 12-2, the MN-CSE 12-2 will be able to retrieve the corresponding service profile from the IN-CSE 12-1. More generally, the MN-CSE 12-2 will be able to retrieve service provider affiliation information from the IN-CSE 12-1, so that the MN-CSE 12-2 can determine and store the SP affiliation of the AE 22-1. Such data may be stored in a SP affiliation table, where the table is denoted in the diagram as a “SP Table” and it indicates the SP affiliations for the M2M entities registered with the MN-CSE 12-2 and for the M2M resources 50 that are stored and managed by the MN-CSE 12-2. In turn, such information enables the MN-CSE 12-2 to tag or otherwise mark subsequent transactions involving the AE 22-1, such as resource creation request, with the correct SP affiliation information.

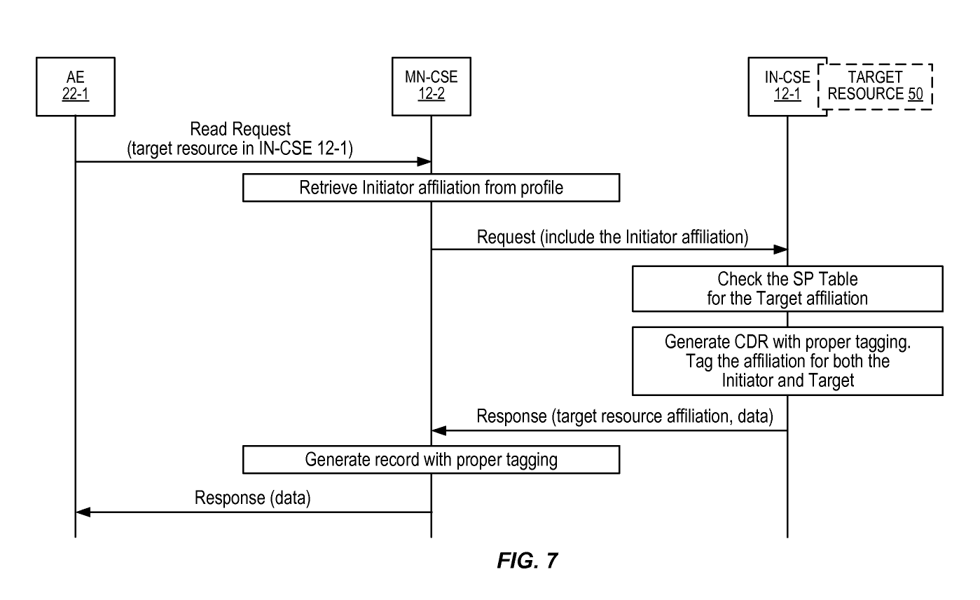

FIG. 7 illustrates another example call flow, where the AE 22-1 makes a read request towards a M2M resource 50 that is maintained in the IN-CSE 12-1. The supporting MN-CSE 12-2 forwards the request from the AE 22-1 towards the IN-CSE 12-1, and tags the forwarded request with M2M SP affiliation information for the AE 22-1. Here the AE 22-1 will be understood as the transaction initiator 100 and the targeted M2M resource will be understood as the transaction target 102.

The IN-CSE 12-1 receives the forwarded request and uses the SP affiliation information included in the request signaling from the MN-CSE 12-2, along with its knowledge of the SP affiliation of the targeted M2M resource 50, to generate a transaction record and/or CDR with the proper SP affiliation tagging. Note that the IN-CSE 12-1 may return the SP affiliation of the targeted M2M resource 50 to the supporting MN-CSE 12-2, for use by the MN-CSE 12-2 in recording a transaction record with complete SP affiliation information for the transaction initiator 100 and the transaction target 102.

In another contemplated variation, the MN-CSE 12-2 does not tag or otherwise include SP affiliation information in the forwarded read request, based on the fact that the IN-CSE 12-1 will, in at least some embodiments, already have service profiles or other information that identifies the SP affiliations of every M2M entity and M2M resource in the M2M network 10. It is also possible to omit the transaction target SP affiliation information included in the read request response sent from the IN-CSE 12-1 to the MN-CSE 12-2. For example, the transaction target 102 could have been previously announced to the MN-CSE 12-2, to make it visible to the AE 22-1, and the announcement may include SP affiliation information.

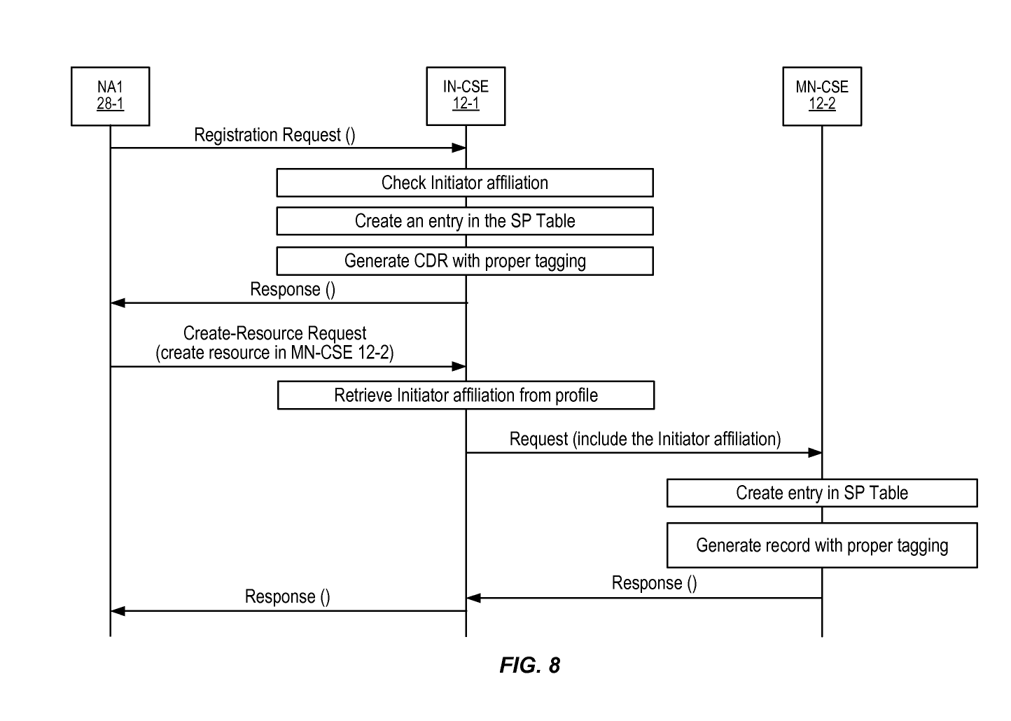

FIG. 8 illustrates the transfer, use and/or storage of M2M SP affiliation information in the context of resource creation for a network application, “NA” in the diagram, where a network application 28-1 with a given M2M SP affiliation registers with an IN-CSE 12-1. Subsequently, the network application 28-1 sends a resource creation request to the IN-CSE 12-1, requesting the creation of a M2M resource 50. The resource request indicates that the M2M resource 50 is to be created in a MN-CSE 12-2.

Thus, the transaction initiator 100 in this example is the network application 28-1 and the transaction target 102 is the M2M resource 50 to be created at the MN-CSE 12-2. Generally speaking, the M2M SP affiliation of a given M2M resource 50 will be that of the M2M entity that created it. For example, the network application 28-1 and the MN-CSE 12-2 may have different SP affiliations but the network application 28-1 can create a M2M resource 50 at the MN-CSE 12-2 that is tagged with the same SP affiliation as that of the network application 28-1. Despite the network application 28-1 and the corresponding M2M resource 50 at the MN-CSE 12-2, M2M transactions involving the network application 28-1 and the M2M resource 50 stored at the MN-CSE 12-2 may still be regarded as involving different M2M SPs, because the storage and/or processing resources of the MN-CSE 12-2 are being used by network application 28-1 and the stored M2M resource 50.

To enable such differentiation, the MN-CSE 12-2 receives the affiliation of NA 28-1 in signaling from IN-CSE 12-1, and stores it in the SP affiliation table for M2M resources 50 hosted at the MN-CSE 12-2 for NA 28-1. Then, when the NA 28-1 accesses one of those hosted resources 50 via the IN-CSE 12-1, the MN-CSE 12-2 creates a M2M event record that records the M2M SP affiliation of the NA 28-1 as the transaction initiator 100 and the M2M SP affiliation of the targeted resource 50 as the transaction target 102. The MN-CSE 12-2 may also include an indication of its M2M SP affiliation in the record. In any case, any downstream billing processing of the record can differentiate charging based on these recorded M2M SP affiliations.

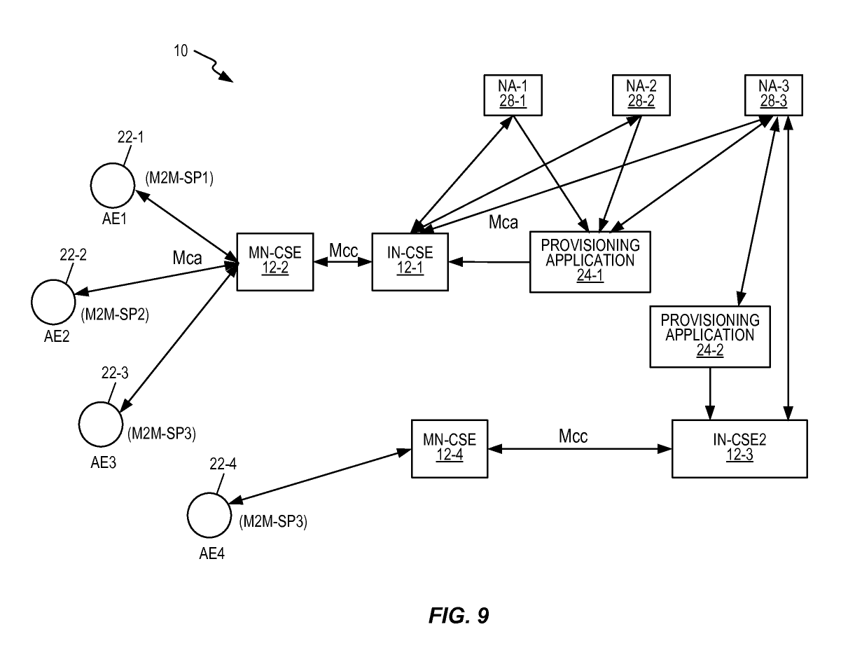

FIG. 9 provides one example of a more complicated scenario, and it should be appreciated that even more complicated scenarios, in which the lessor SPs own their own IN-CSE, but lease capacity from the M2M SP that owns the overall network for MN-CSE 12. Still further, the M2M network 10 may include or be associated with more than one provisioning application 24, e.g., applications 24-1 and 24-2, and more than one provisioning application server 26 due to the fact that each IN-CSE 12 has to be provisioned the necessary information in accordance with FIG. 5 by the M2M SP that owns the IN-CSE 12. A given M2M-CSE 12 will be pre-configured with the IN-CSEs 12 that can provision information in them based on business agreements.

In an example case, the MN-CSE 12-2 and MN-CSE 12-4 are owned by the M2M SP that owns the M2M network 10 at large. Furthermore, the M2M SP that owns the overall M2M network 10 owns IN-CSE 12-1. M2M SP 3, a lessor SP, owns IN-CSE 12-3.

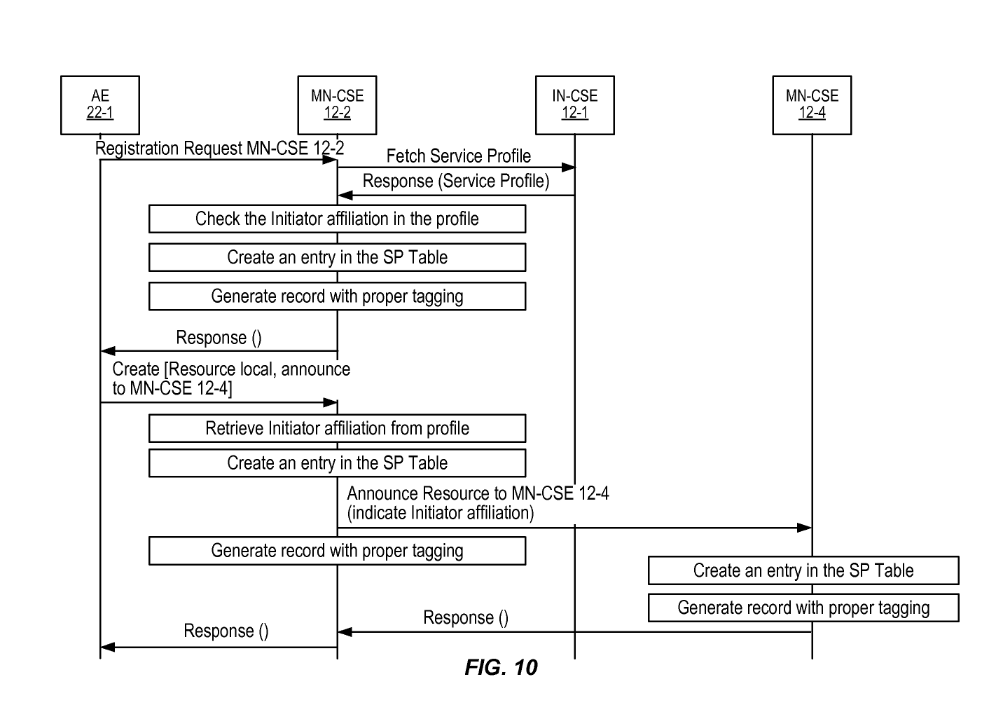

With these possibilities in mind, FIG. 10 illustrates a registration process, followed by resource creation. Here, the AE 22-1, the MN-CSE 12-2 and the IN-CSE 12-1 are all associated with a lessor M2M SP, while another MN-CSE 12-4 is affiliated with a different M2M SP.

The AE 22-1 registers with the MN-CSE 12-2, which obtain SP affiliation for the AE 22-1 from the IN-CSE 12-1, e.g., by obtaining a service profile for the AE 22-1. Subsequent to this registration, the AE 22-1 creates a M2M resource 50 that will be announced to the MN-CSE 12-4. The MN-CSE 12-2 provides announcement signaling that includes the SP affiliation information for the created M2M resource 50. This announcement signaling allows the MN-CSE 12-4 to record the M2M SP affiliation for the M2M resource 50, and to generate a CDR or other event record that includes the M2M SP affiliation of the announced resource.

More particularly, in the context of the diagram, the registration transaction will result in a CDR or other record being generated at MN-CSE 12-2, while the resource creation request will cause the MN-CSE-12-2 to generate a transaction record and the announcement signaling causes the MN-CSE 12-4 to record the SP affiliation information in an event record.

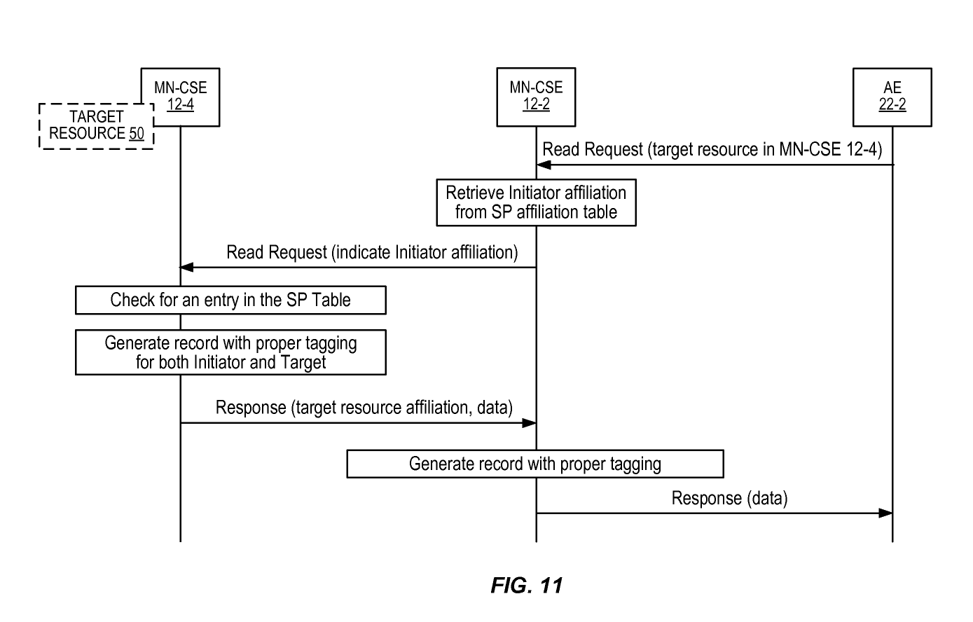

FIG. 11 illustrates another example where one may assume that an AE 22-2 is affiliated with a first M2M SP, and that a MN-CSE 12-4 is affiliated with a different, second M2M SP. One may further assume that the MN-CSE 12-4 hosts a M2M resource 50 that is affiliated with the first M2M SP. The depicted MN-CSE 12-2 may be affiliated with either the first or second M2M SPs, or with yet another M2M SP.

In any case, the AE 22-2 here acts as a transaction initiator 100, by making a read request towards the M2M resource 50 hosted at the MN-CSE 12-4, as the transaction target 102. The MN-CSE 12-2 in some sense “proxies” this request, by receiving the request from the AE 22-2 and forwarding it to the MN-CSE 12-4. Advantageously, the forwarded read request includes M2M SP affiliation information for the AE 22-2. Here the AE 22-2 necessarily will have already been registered at the MN-CSE 12-2. Thus, the MN-CSE 12-2 already knows the M2M SP affiliation of the AE 22-2, based on previously storing the SP affiliation information for the AE 22-2 in its SP affiliation table, in conjunction with registration of the AE 22-2.

The M2M SP affiliation information included in the forwarded read request allows the MN-CSE 12-4 to generate a CDR or other transaction record that includes the M2M SP affiliations of the targeted resource 50, the host node—i.e., the MN-CSE 12-4—and the transaction initiator AE 22-2. Correspondingly, the MN-CSE 12-4 returns M2M SP affiliation information for the targeted M2M resource 50, along with the requested data. This return signaling allows the MN-CSE 12-2 to generate a CDR or other transaction record that includes all relevant M2M SP affiliation information.

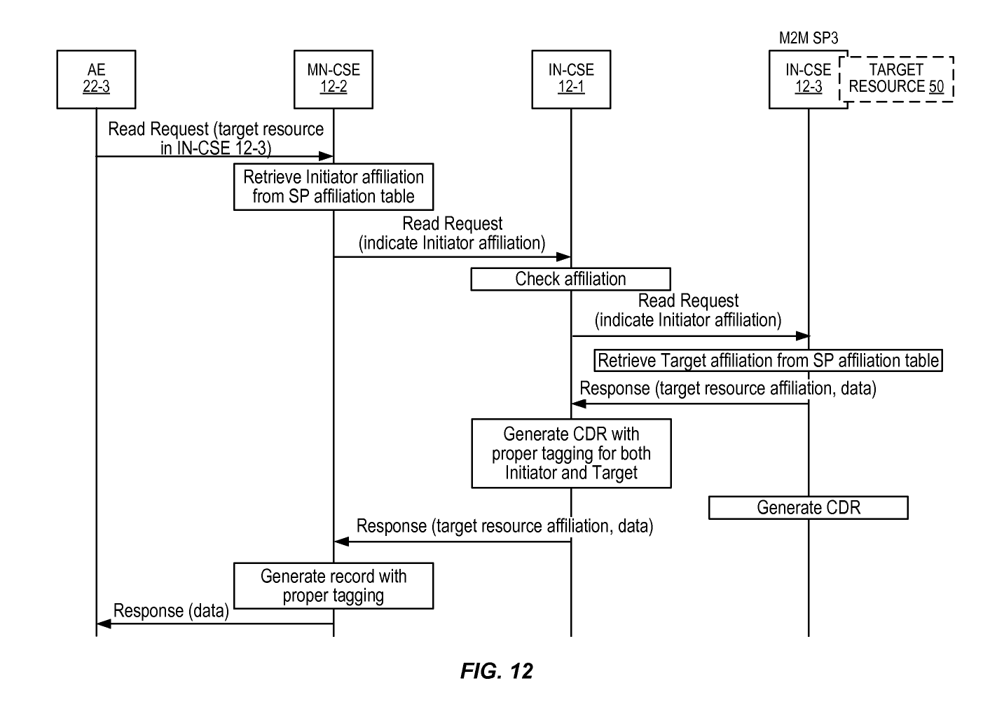

FIG. 12 illustrates a similar resource reading example. Notably, however, the read request in FIG. 12 involves two different IN-CSEs 12-1 and 12-3. Here AE 22-3 and IN-CSE 12-3 may be associated with a given M2M SP, while the IN-CSE 12-1 may belong to another M2M SP that owns the overall M2M network 10. The transaction records recorded at each of the involved M2M entities for the illustrated transaction(s) include the relevant SP affiliation information, based on retrieving such information from locally stored information and/or receiving at least some of the affiliation information in the relevant transaction signaling. The locally-stored information at a given MN-CSE and/or IN-CSE comprises, for example, a SP affiliation table that maps the M2M entities and/or M2M resources registered with or hosted by the MN-CSE or IN-CSE to their respective M2M SPs.

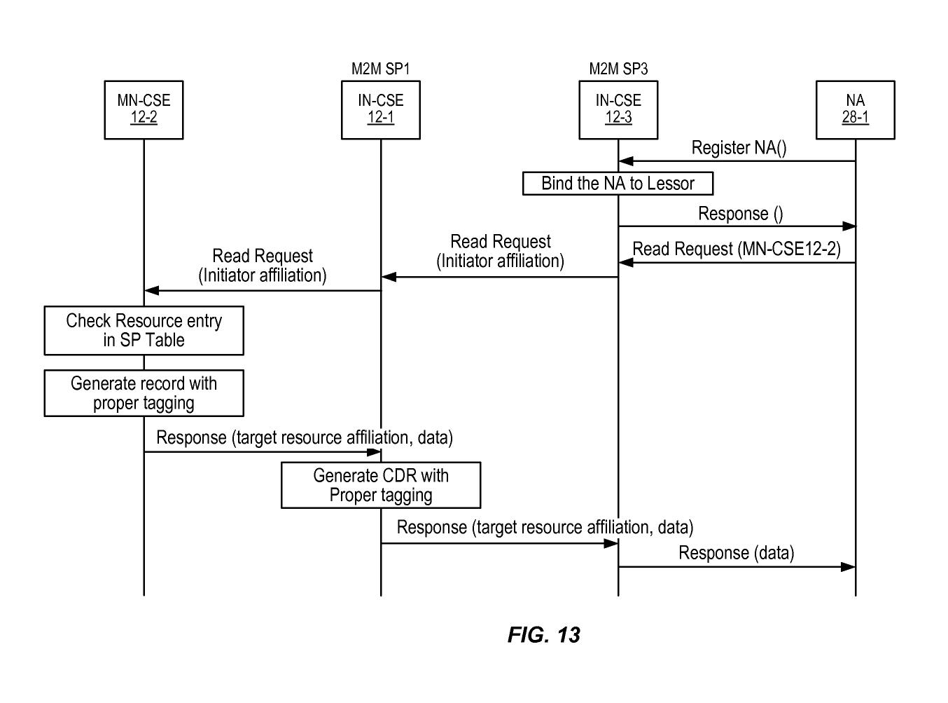

FIG. 13 illustrates an example case that involves distinguishing between inter-SP traffic and is based on a NA 28-1 that belong to a given M2M SP and registers with an IN-CSE 12-3 that belongs to the same M2M SP. The NA 28-1 subsequently makes a read request towards a M2M resource 50 which belongs to another M2M SP, and which is hosted at the MN-CSE 12-2. The request is forwarded by the IN-CSE 12-1, which is owned by the owner of the network 10. Note that this owner may be the same M2M SP that owns the MN-CSE 12-2.

In any case, IN-CSE 12-3 provides the IN-CSE 12-1 with M2M SP affiliation information for the NA 28-1 as the transaction initiator 100, and the IN-CSE 12-1 in turn provides that affiliation information to the MN-CSE 12-2. Correspondingly, the MN-CSE 12-2 provides the target affiliation information to the IN-CSE 12-1, and the IN-CSE 12-1 also may provide that affiliation information to the IN-CSE 12-3, as part of providing the requested data. The inclusion of M2M SP affiliation information in the exchanged transaction signaling allows each of the involved M2M nodes to record the relevant M2M SP affiliation information in the corresponding transaction record generated at the M2M node.

Additional operational aspects worth noting are that the ADNs 20 belonging to a lessee M2M SP may be identical or essentially identical to the ADNs 20 belonging to a lessor M2M SP, thus the various M2M entities/nodes through which ADN-related traffic flows must be able to identify the SP affiliations of the different traffic flows. In general, the teachings herein provide a mechanism for distinguishing the M2M resources 50 associated with different M2M entities, e.g., associated with different ADNs 20, according to the respective SP affiliations of the ADNs 20. This SP affiliation information can be included as attributes in the signaling and in the transaction records, regardless of whether the transaction target 102 in a transaction involving an AE 22 is where the AE 22 created resources or registered.

Thus, the teachings herein broadly provide for tagging or identifying traffic—M2M data and/or control signaling—according to the M2M SPs that are involved and allows traffic involving lessor/lessee relationships to be distinguished from, e.g., “normal” inter-SP traffic going between M2M network domains owned by different M2M SPs. That is, according to the teachings herein, different M2M entities and/or resources within the same M2M network domain may be affiliated with different M2M SPs, such as where one M2M SP leases CSE services to another M2M SP, and where individual M2M transactions conducted within the M2M network in question are tagged at the respective entities/nodes supporting those transactions, so that billing can be differentiated between transactions involving the lessor SP and those involving the lessee SP.

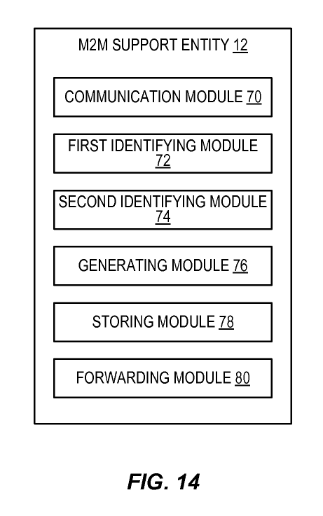

FIG. 14 illustrates a M2M SE 12 configured accordingly, wherein the M2M SE 12 is configured for operation in a M2M network 10 that includes any number of other M2M entities, e.g., entities 12, 22 and/or 28. The M2M SE 12 includes a communication module 70 for sending and receiving M2M signaling to one or more of the other M2M entities 12, 22, 28, and a number of further modules for supporting M2M transactions involving given M2M entities 12, 22, 28 and given M2M resources 50 in the M2M network 10, where given ones of the other M2M entities may be affiliated with different M2M SPs.

In an example configuration, the M2M SE 12 includes a first identifying module 72 for identifying a transaction initiator 100 and a transaction target 102, for a given transaction being supported by the M2M SE 12. Here, the transaction initiator 100 comprises the given M2M entity in the M2M network 10 that initiated the transaction and the transaction target 102 comprises the given M2M resource 50 in the M2M network 10 that is targeted by the given transaction. The M2M SE 12 in this example embodiment further includes a second identifying module 74 for identifying M2M SP affiliations of the transaction initiator 100 and the transaction target 102, and a generating module 76 for generating a transaction record for the given transaction, and including in the transaction record the M2M SP affiliations of the transaction initiator 100 and the transaction target 102. Further, the M2M SE 12 includes a storing module 78 for storing the transaction record at least temporarily in storage at the M2M SE 12, and a forwarding module 80 for forwarding the transaction record, or a CDR derived therefrom, towards a billing system 32 associated with the M2M network 10, for billing in dependence on the M2M SP affiliations of the transaction initiator 100 and the transaction target 102.

In an example business model, a first M2M SP allows other M2M SPs to use the gateway nodes and infrastructure nodes of the first M2M SP, for storing resources belonging to applications managed by the other M2M SPs. The other M2M SPs still own the applications and the corresponding M2M subscriptions, but they lease the actual M2M network capabilities from the first M2M SP. They use the hardware from another large M2M SP for a fee.

In another contemplated business model, a first M2M SP allows other M2M SPs to use the gateway nodes of the first M2M SP only for storing resources belonging to the other M2M SPs. These other M2M SPs own their M2M applications and the corresponding M2M subscriptions, and the supporting IN-CSE, but they lease rather than own the MN-CSEs acting as gateways between their subscribers' ADNs and their IN-CSE.

In another aspect contemplated herein, the type of service level agreement, SLA, between a lessor M2M SP and a lessee M2M SP can be recorded in the M2M event records or CDRs generated for any given M2M event that is tracked and tagged with M2M SP affiliation information. This enables distinguishing different SLAs for an M2M SP that has multiple business models with the same M2M SP. This type information adds a further dimension to differentiated billing, wherein the billing for a given M2M transaction may be differentiated based on the specific M2M SPs, or mix of SPs, involved in the transaction, and further based on the type of the transaction.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-25. (canceled)

26. A method at a Machine-to-Machine, M2M, Support Entity, SE, operating in a Machine-to-Machine, M2M, network, wherein the M2M SE supports M2M transactions involving given M2M entities and given M2M resources in the M2M network that are affiliated with different M2M Service Providers, SPs, and wherein the method comprises:
identifying a transaction initiator and a transaction target, for a given transaction being supported by the M2M SE, wherein the transaction initiator comprises a given M2M entity in the M2M network that initiated the transaction and the transaction target comprises a given M2M resource in the M2M network that is targeted by the given transaction;
identifying M2M SP affiliations of the transaction initiator and the transaction target;
generating a transaction record for the given transaction, and including in the transaction record the M2M SP affiliations of the transaction initiator and the transaction target;
storing the transaction record at least temporarily in storage at the M2M SE; and
forwarding the transaction record, or a Charging Data Record, CDR, derived therefrom, towards a billing system associated with the M2M network, for billing in dependence on the M2M SP affiliations of the transaction initiator and the transaction target.

27. The method of claim 26, wherein identifying the M2M SP affiliations of the transaction initiator and the transaction target is based on at least one of: information received by the M2M SE in conjunction with the given transaction, and affiliation information stored in the M2M SE in advance of the given transaction.

28. The method of claim 26, wherein identifying the M2M SP affiliations of the transaction initiator and the transaction target comprises:
receiving a M2M identifier of the transaction initiator and/or a M2M identifier of the transaction target, in M2M signaling received by the M2M SE, in conjunction with the transaction; and
identifying the M2M SP affiliations of the transaction initiator and the transaction target, using the affiliation information stored at the M2M SE, wherein the affiliation information maps the M2M identifiers received for the transaction initiator and the transaction target to respective M2M SP identifiers.

29. The method of claim 26, wherein the transaction initiator is not registered with the M2M SE, and wherein identifying the M2M SP affiliation of the transaction initiator comprises extracting an indication of the M2M SP affiliation of the transaction initiator from M2M signaling received by the M2M SE in conjunction with the transaction.

30. The method of claim 29, wherein the M2M SE stores the transaction target (102), the transaction initiator is registered at another M2M SE in the M2M network, the transaction is a request to access the transaction target, and identifying the M2M SP affiliation of the transaction target comprises accessing the affiliation information stored at the M2M SE.

31. The method of claim 26, wherein the transaction target is not hosted at the M2M SE, and wherein identifying the M2M SP affiliation of the transaction target comprises extracting an indication of the M2M SP affiliation of the transaction target from M2M signaling received by the M2M SE in conjunction with the transaction.

32. The method of claim 26, wherein the transaction comprises a M2M request in which the transaction initiator requests access to the transaction target.

33. The method of claim 26, wherein the M2M SE comprises one of a Middle Node Common Services Entity, MN-CSE, and an Infrastructure Node Common Services Entity, IN-CSE.

34. The method of claim 26, wherein the M2M SE comprises a Middle Node Common Services Entity, MN-CSE, and wherein the method includes registering the transaction initiator prior to the transaction, and wherein registering the transaction initiator comprises:
receiving a registration request from the transaction initiator;
requesting service profile information for the transaction initiator, from an Infrastructure Node CSE, IN-CSE, in the M2M network;
receiving the service profile information, from the IN-CSE, the service profile information including an indication of the M2M SP affiliation of the transaction initiator; and
storing the indication of the M2M SP affiliation of the transaction initiator at the MN-CSE.

35. The method of claim 26, wherein the M2M SE comprises an Infrastructure Node Common Services Entity, IN-CSE, and wherein the method includes obtaining the M2M SP affiliation of the transaction initiator in advance of the transaction, based on receiving provisioning information from a provisioning application running on a provisioning application server.

36. The method of claim 26, wherein forwarding the transaction record, or the Charging Data Record, CDR, derived therefrom, towards the billing system associated with the M2M network comprises generating the CDR from the transaction record and forwarding the CDR individually, or batched together with one or more other CDRs associated with the same transaction or with one or more other transactions previously supported by the M2M SE.

37. The method of claim 26, further comprising recording a transaction type for the given transaction in the transaction record.

38. A first Machine-to-Machine, M2M, node configured for operation as a M2M Support Entity, M2M SE, in a M2M network that includes the first M2M node and a number of other M2M entities, which may be affiliated with different M2M Service Providers, SPs, said first M2M node comprising:
one or more communication interfaces configured to send and receive M2M signaling to one or more of the other M2M entities; and
processing circuitry operatively associated with the one or more communication interfaces and operative to support M2M transactions involving given M2M entities and given M2M resources in the M2M network that are affiliated with different M2M SPs, based on being configured to:
identify a transaction initiator and a transaction target, for a given transaction being supported by the M2M SE, wherein the transaction initiator comprises the given M2M entity in the M2M network that initiated the transaction and the transaction target comprises the given M2M resource in the M2M network that is targeted by the given transaction;
identify M2M SP affiliations of the transaction initiator and the transaction target;
generate a transaction record for the given transaction, and include in the transaction record the M2M SP affiliations of the transaction initiator and the transaction target;
store the transaction record at least temporarily in storage at the M2M SE; and
forward the transaction record, or a Charging Data Record, CDR, derived therefrom, towards a billing system associated with the M2M network, for billing in dependence on the M2M SP affiliations of the transaction initiator and the transaction target.

39. The first M2M node of claim 38, wherein the processing circuitry is configured to identify the M2M SP affiliations of the transaction initiator and the transaction target based on at least one of: information received by the M2M SE in conjunction with the given transaction, and affiliation information stored in the M2M SE in advance of the given transaction.

40. The first M2M node of claim 38, wherein the processing circuitry is configured to identify the M2M SP affiliations of the transaction initiator and the transaction target, by:
receiving a M2M identifier of the transaction initiator and/or a M2M identifier of the transaction target, in M2M signaling received by the M2M SE, in conjunction with the transaction; and
identifying the M2M SP affiliations of the transaction initiator and the transaction target, using the affiliation information stored at the M2M SE, wherein the affiliation information maps the M2M identifiers received for the transaction initiator and the transaction target to respective M2M SP identifiers.

41. The first M2M node of claim 38, wherein the transaction initiator is not registered with the M2M SE, and wherein the processing circuitry is configured to identify the M2M SP affiliation of the transaction initiator by extracting an indication of the M2M SP affiliation of the transaction initiator from M2M signaling received by the M2M SE in conjunction with the transaction.

42. The first M2M node of claim 41, wherein the M2M SE stores the transaction target, the transaction initiator is registered at another M2M SE in the M2M network, the transaction is a request to access the transaction target, and wherein the processing circuitry is configured to identify the M2M SP affiliation of the transaction target by accessing the affiliation information stored at the MN SE.

43. The first M2M node of claim 38, wherein the transaction target is not hosted at the M2M SE, and wherein the processing circuitry is configured to identify the M2M SP affiliation of the transaction target by extracting an indication of the M2M SP affiliation of the transaction target from M2M signaling received by the M2M SE in conjunction with the transaction.

44. The first M2M node of claim 38, wherein the transaction comprises a M2M request in which the transaction initiator requests access to the transaction target.

45. The first M2M node of claim 38, wherein the M2M SE comprises one of a Middle Node Common Services Entity, MN-CSE, and an Infrastructure Node Common Services Entity, IN-CSE.

46. The first M2M node of claim 38, wherein the M2M SE comprises a Middle Node Common Services Entity, MN-CSE, and wherein the processing circuitry is configured to register the transaction initiator prior to the transaction, based on being configured to:
receive a registration request from the transaction initiator;
request service profile information for the transaction initiator, from an Infrastructure Node Common Services Entity, IN-CSE;
receive the service profile information, from the IN-CSE, the service profile information including an indication of the M2M SP affiliation of the transaction initiator; and
store the indication of the M2M SP affiliation of the transaction initiator at the MN-CSE.

47. The first M2M node of claim 38, wherein the M2M SE comprises an Infrastructure Node Common Services Entity, IN-CSE, and wherein the processing circuitry is configured to obtain the M2M SP affiliation of the transaction initiator in advance of the transaction, based on receiving provisioning information from a provisioning application running on a provisioning application server.

48. The first M2M node of claim 38, wherein the processing circuitry is configured to forward the transaction record, or the Charging Data Record, CDR, derived therefrom, towards the billing system associated with the M2M network, based on generating the CDR from the transaction record and forwarding the CDR individually, or batched together with one or more other CDRs associated with the same transaction or with one or more other transactions previously supported by the M2M SE.

49. The first M2M node of claim 38, wherein the processing circuitry is configured to record a transaction type for the given transaction in the transaction record.

50. A first Machine-to-Machine, M2M, Support Entity, SE implemented at a first M2M node in a M2M network that includes a number of other M2M entities, said first M2M SE comprising:
a communication module for sending and receiving M2M signaling to one or more of the other M2M entities; and
a number of further modules for supporting M2M transactions involving given M2M entities and given M2M resources in the M2M network that are affiliated with different M2M SPs, including:
a first identifying module for identifying a transaction initiator and a transaction target, for a given transaction being supported by the M2M SE, wherein the transaction initiator comprises the given M2M entity in the M2M network that initiated the transaction and the transaction target comprises the given M2M resource in the M2M network that is targeted by the given transaction;
a second identifying module for identifying M2M SP affiliations of the transaction initiator and the transaction target;
a generating module for generating a transaction record for the given transaction, and including in the transaction record the M2M SP affiliations of the transaction initiator and the transaction target;
a storing module for storing the transaction record at least temporarily in storage at the M2M SE; and
a forwarding module for forwarding the transaction record, or a Charging Data Record, CDR, derived therefrom, towards a billing system associated with the M2M network, for billing in dependence on the M2M SP affiliations of the transaction initiator and the transaction target.
